(19) United States
(12) Patent Application Publication
(10) Pub. No.: US 2021/0256024 A1
(43) Pub. Date: Aug. 19, 2021

(54) DIALOGUE DEVICE, DIALOGUE METHOD, AND NON-TRANSITORY COMPUTER-READABLE STORAGE MEDIUM

(71) Applicant: Mitsubishi Electric Corporation, Tokyo (JP)

(72) Inventors: Katsuki KOBAYASHI, Tokyo (JP); Shinya TAGUCHI, Tokyo (JP)

(73) Assignee: Mitsubishi Electric Corporation, Tokyo (JP)

(21) Appl. No.: 17/307,191

(22) Filed: May 4, 2021

Related U.S. Application Data
(63) Continuation of application No. PCT/JP2018/043897, filed on Nov. 29, 2018.

(51) Int. Cl. G06F 16/2453; G06F 16/242

(52) U.S. Cl. CPC G06F 16/24547; G06F 16/2423; G06F 16/24537

(57) ABSTRACT

A dialogue device to execute a dialogue with a user in accordance with a dialogue scenario includes: a processor to execute a program; and a memory to store the program which, when executed by the processor, performs processes of: acquiring multiple processing states in dialogue and relation information indicating a relation between the multiple processing states, and constructing, based on the multiple processing states and the relation information, a diagram describing an entirety of a designed dialogue function; and searching, based on information dynamically acquired before an actual dialogue from a surrounding situation in using the dialogue device, the diagram describing the entirety of the designed dialogue function for one or more processing states that appear in the actual dialogue, among the multiple processing states in the diagram describing the entirety of the designed dialogue function, and dynamically determining the dialogue scenario including the processing states obtained by the search.

### CROSS REFERENCE TO RELATED APPLICATION

This application is a continuation of International Application No. PCT/JP2018/043897, filed on Nov. 29, 2018, the disclosure of which is incorporated herein by reference in its entirety.

### BACKGROUND OF THE INVENTION

### 1. Field of the Invention

The present invention relates to a dialogue device that executes a dialogue in accordance with a dialogue scenario, and a dialogue method and a non-transitory computer-readable storage medium that are used to execute a dialogue in accordance with a dialogue scenario.

### 2. Description of the Related Art

Electrical devices, such as car navigation devices or electrical household appliances, provided with human machine interfaces (HMIs) are commonly used. In such electrical devices, responses to inquiries from users, inquiries to users, or the like are performed in accordance with previously designed dialogue scenarios indicating the flows of dialogue processes. A dialogue device that executes a dialogue in accordance with a dialogue scenario is installed with dialogue function information that is design information, such as processing states (e.g., states, such as an input waiting state or a searching state) in a dialogue and transition information indicating transitions between the processing states. The dialogue function information can be described by a diagram, such as a state chart or a flowchart, representing state transitions.

Also, there have been proposed various devices and methods that allow reduction in the effort in the design and maintenance of dialogue devices, or the like (see, e.g., Patent Literatures 1 and 2).

Patent Literature 1: Japanese Patent Application Publication No. 2001-324993

Patent Literature 2: Japanese Translation of PCT International Application Publication No. 2008-512789

By the way, with the spread of Artificial Intelligence (AI), Internet of Things (IoT), or the like, dialogue devices are demanded to provide advanced dialogue functions using various information, such as detection signals provided from sensors, information provided on the Web (e.g., the Internet), or information (e.g., individual information) indicating preferences of users who have dialogues with the dialogue devices. Thus, in dialogue devices, the number of conditions that should be taken into account has significantly increased, and as a result, dialogue scenarios have become very complicated.

However, there is a problem in that, in order for the above conventional dialogue devices to provide advanced dialogue functions using various information, it is necessary to manually create and modify complicated dialogue scenarios.

### SUMMARY OF THE INVENTION

The present invention has been made to solve the above conventional problem, and is intended to provide a dialogue device capable of dynamically determining dialogue scenarios satisfying various conditions and executing advanced dialogues in accordance with the dialogue scenarios, and a dialogue method and a non-transitory computer-readable storage medium that make it possible to dynamically determine dialogue scenarios satisfying various conditions and execute advanced dialogues in accordance with the dialogue scenarios.

A dialogue device according to an aspect of the present invention is a dialogue device to execute a dialogue with a user in accordance with a dialogue scenario, the dialogue device including: a processor to execute a program; and a memory to store the program which, when executed by the processor, performs processes of: (a) acquiring a plurality of processing states in dialogue and relation information indicating a relation between the plurality of processing states, and constructing, on a basis of the plurality of processing states and the relation information, a diagram describing an entirety of a designed dialogue function; and (b) searching, on a basis of information dynamically acquired before an actual dialogue from a surrounding situation in using the dialogue device, the diagram describing the entirety of the designed dialogue function for one or more processing states that appear in the actual dialogue, among the plurality of processing states in the diagram describing the entirety of the designed dialogue function, and dynamically determining the dialogue scenario including the processing states obtained by the search.

A dialogue method according to another aspect of the present invention is a dialogue method executed by a dialogue device that executes a dialogue with a user in accordance with a dialogue scenario, the dialogue method including: acquiring a plurality of processing states in dialogue and relation information indicating a relation between the plurality of processing states, and constructing, on a basis of the plurality of processing states and the relation information, a diagram describing an entirety of a designed dialogue function; and searching, on a basis of information dynamically acquired before an actual dialogue from a surrounding situation in using the dialogue function, the diagram describing the entirety of the designed dialogue function for one or more processing states that appear in the actual dialogue, among the plurality of processing states in the diagram describing the entirety of the designed dialogue function, and dynamically determining the dialogue scenario including the processing states obtained by the search.

The dialogue device according to the present invention can dynamically determine dialogue scenarios satisfying various conditions and execute advanced dialogues in accordance with the dialogue scenarios.

Also, the use of the dialogue method or non-transitory computer-readable storage medium according to the present invention makes it possible to dynamically determine dialogue scenarios satisfying various conditions and execute advanced dialogues in accordance with the dialogue scenarios.

### BRIEF DESCRIPTION OF DRAWINGS

FIG. 1 is a block diagram schematically illustrating a configuration of a dialogue device according to a first embodiment of the present invention.

FIG. 2 is a diagram illustrating an example of a hardware configuration of the dialogue device according to the first embodiment.

FIG. 3 is a flowchart illustrating an operation of the dialogue device according to the first embodiment.

FIG. 4 is a diagram illustrating an example of a state list acquired by a dialogue designer of the dialogue device according to the first embodiment.

FIG. 5 is a diagram illustrating an example of an appearance order that is a construction condition acquired by the dialogue designer of the dialogue device 1 according to the first embodiment.

FIG. 6 is a diagram illustrating an example of transition information that is a construction condition acquired by the dialogue designer of the dialogue device according to the first embodiment.

FIG. 7 is a diagram illustrating an example of a complete directed graph constructed from the state list by the dialogue designer of the dialogue device according to the first embodiment.

FIG. 8 is a diagram illustrating an example of the complete directed graph constructed by the dialogue designer of the dialogue device according to the first embodiment and a state chart created from the complete directed graph.

FIG. 9 is a diagram illustrating the state chart in FIG. 8.

FIG. 10 is a diagram illustrating an example of search conditions acquired by a dialogue executor of the dialogue device according to the first embodiment.

FIG. 11 is a diagram illustrating an example of a dialogue scenario obtained by the dialogue executor of the dialogue device according to the first embodiment.

FIG. 12 is a diagram illustrating another example of the dialogue scenario obtained by the dialogue executor of the dialogue device according to the first embodiment.

FIG. 13 is a diagram illustrating an example of a state list acquired by the dialogue designer of the dialogue device according to the first embodiment and a complete directed graph constructed from the state list.

FIG. 14 is a diagram illustrating an example of a dialogue scenario in case #1 of FIG. 13.

FIG. 15 is a diagram illustrating an example of a dialogue scenario in case #2 of FIG. 13.

FIG. 16 is a diagram illustrating an example of a dialogue scenario in case #3 of FIG. 13.

FIG. 17 is a block diagram schematically illustrating a configuration of a dialogue device according to a second embodiment of the present invention.

FIG. 18 is a flowchart illustrating an operation of the dialogue device according to the second embodiment.

FIG. 19 is a block diagram schematically illustrating a configuration of a dialogue device according to a third embodiment of the present invention.

FIG. 20 is a flowchart illustrating an operation of the dialogue device according to the third embodiment.

### DETAILED DESCRIPTION OF THE INVENTION

Hereinafter, dialogue devices, dialogue methods, and dialogue programs according to embodiments of the present invention will be described with reference to the attached drawings. The following embodiments are merely examples, and can be modified in various ways within the scope of the present invention.

### <<1>> First Embodiment

### <<1-1>> Configuration of First Embodiment

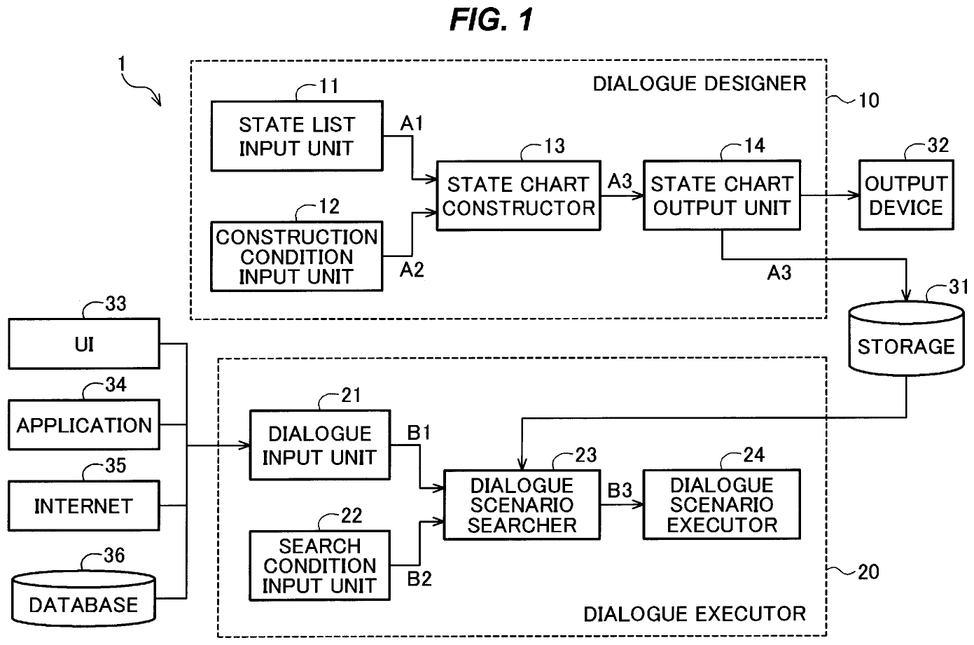

FIG. 1 is a block diagram schematically illustrating a configuration of a dialogue device 1 according to a first embodiment of the present invention. The dialogue device 1 is a device capable of implementing a dialogue method according to the first embodiment. As illustrated in FIG. 1, the dialogue device 1 includes a dialogue designer 10 and a dialogue executor 20. The dialogue device 1 executes a dialogue with a user in accordance with a dialogue scenario. The dialogue device 1 may include a storage 31, such as a semiconductor memory or a hard disk drive. Also, the dialogue device 1 may include an output device 32 including a display screen.

The dialogue designer 10 includes a state list input unit 11 that acquires, as a state list, multiple states A1 that are multiple processing states in dialogue, and a construction condition input unit 12 that acquires one or more construction conditions A2 that are relation information indicating a relation between the multiple states A1. Also, the dialogue designer 10 includes a state chart constructor 13 that constructs, on the basis of the multiple states A1 and the construction conditions A2, a state chart A3, i.e., a state transition diagram, that is a diagram describing the entirety of a designed dialogue function, and a state chart output unit 14 that outputs the constructed state chart A3. The state chart A3 is stored in the storage 31. Also, the state chart A3 may be displayed on the display screen of the output device 32.

The construction conditions A2 are one or more conditions indicating the static structure of a state chart, such as a transition relation between the multiple states A1, an order relation of transition between the multiple states A1, or one or more constraint conditions of one or more transition lines that connect between the multiple states A1 to represent the transition relation between the multiple states. The state chart constructor 13 constructs the state chart A3 describing the entirety of the dialogue function, on the basis of transition information, order information, the constraint conditions, or the like.

The first embodiment describes a case where the diagram describing the entirety of the dialogue function is a state chart. However, the diagram describing the entirety of the dialogue function may be another form of diagram capable of representing the behavior of the dialogue function, or transitions between the processing states. For example, the diagram describing the entirety of the dialogue function may be one of a behavior tree, an activity diagram, a sequence diagram, an extensible markup language (XML) diagram, and a graph (e.g., a directed graph).

The dialogue executor 20 includes a dialogue input unit 21 that acquires external information B1 that is information dynamically acquired before an actual dialogue, and a search condition input unit 22 that acquires one or more search conditions B2 regarding one or more paths indicating states passed through in the state chart A3. The dialogue executor 20 includes a dialogue scenario searcher 23 that searches for states that are processing states that appear in the actual dialogue, among the multiple states A1 in the state chart A3, and dynamically determines a dialogue scenario B3 including the states obtained by the search and one or more transition lines connecting between the obtained states. Also, the dialogue executor 20 includes a dialogue scenario executor 24 that executes a dialogue in accordance with the dialogue scenario B3.

The external information B1 is information used in determining a path of states passed through in execution of a dialogue process, among the multiple states in the state chart constructed by the dialogue designer 10. The external information B1 may include, for example, one or more of user operation information provided through a user interface (UI) 33, information provided by an application 34 that is a software program executed by a computer, information provided through a network, such as the Internet 35, and information provided from an external database 36. The user operation information includes, for example, a voice input, a touch operation on a touch screen, an input through a keyboard, or the like.

The search conditions B2 are dynamic conditions for searching for a path passing on the state chart A3 describing the entirety of the dialogue function. In other words, the search conditions B2 are conditions that need to be satisfied by the processing states included in the dialogue scenario.

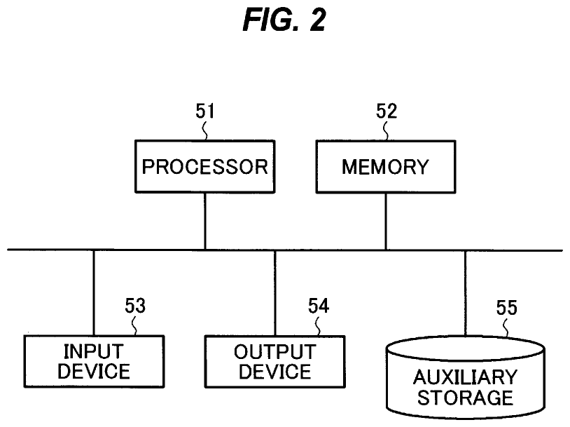

FIG. 2 is a diagram illustrating an example of a hardware configuration of the dialogue device 1 according to the first embodiment. As illustrated in FIG. 2, the dialogue device 1 includes, for example, a memory 52 as a storage that stores a program as software, or a dialogue program according to the first embodiment, and a processor 51 as an arithmetic processor that executes the program stored in the memory 52. The dialogue device 1 is, for example, a computer. The dialogue program according to the first embodiment is stored in the memory 52 through a medium information reader (not illustrated) from a storage medium that stores information or through a communication interface (not illustrated) connectable to the Internet or the like. Also, the dialogue device 1 includes an input device 53 that is a user operation unit, such as a microphone that receives voice of a user, a mouse, or a keyboard. Also, the dialogue device 1 includes an output device 54, such as a display that displays an image, or a sound output unit that outputs sound. Also, the dialogue device 1 may include an auxiliary storage 55 that stores various information, such as a database. The auxiliary storage 55 may be a storage located on a cloud connectable through a communication interface (not illustrated).

The dialogue designer 10 and dialogue executor 20 illustrated in FIG. 1 can be implemented by the processor 51 executing the program stored in the memory 52. Also, part of the dialogue designer 10 and dialogue executor 20 illustrated in FIG. 1 may be implemented by the processor 51 executing the program stored in the memory 52. Also, the storage 31 and database unit 36 illustrated in FIG. 1 may be part of the auxiliary storage 55.

### <<1-2>> Operation of First Embodiment

Next, an operation of the dialogue device 1 according to the first embodiment will be described. The following description describes an example in which the dialogue device 1 is a car navigation device. However, the dialogue device 1 may be an electrical device, such as an electrical household appliance with an interactive HMI, other than a car navigation device.

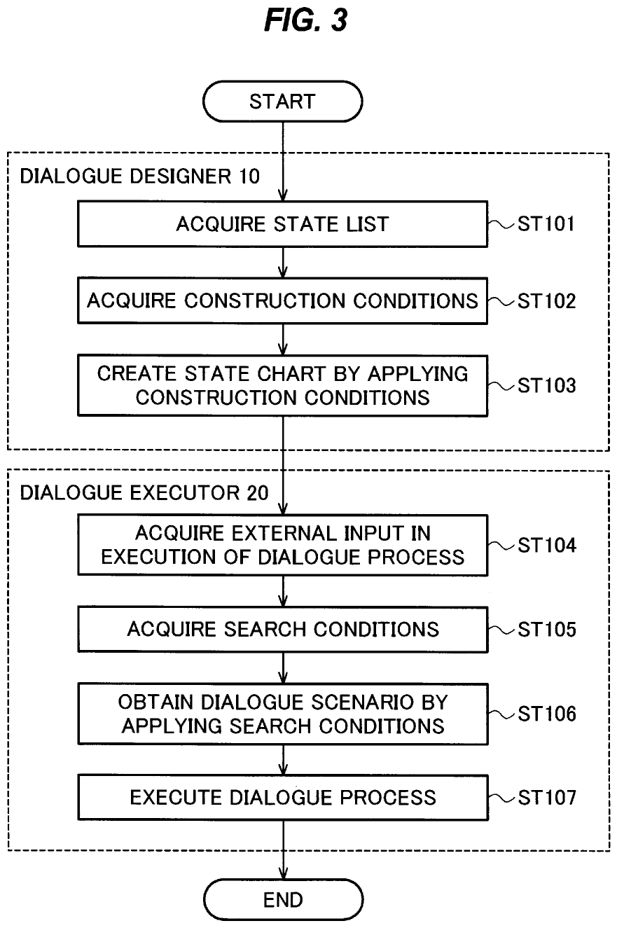

FIG. 3 is a flowchart illustrating an operation of the dialogue device 1 according to the first embodiment. Steps ST101 to ST103 are processes executed by the dialogue designer 10 of the dialogue device 1. Steps ST104 to ST107 are processes executed by the dialogue executor 20 of the dialogue device 1.

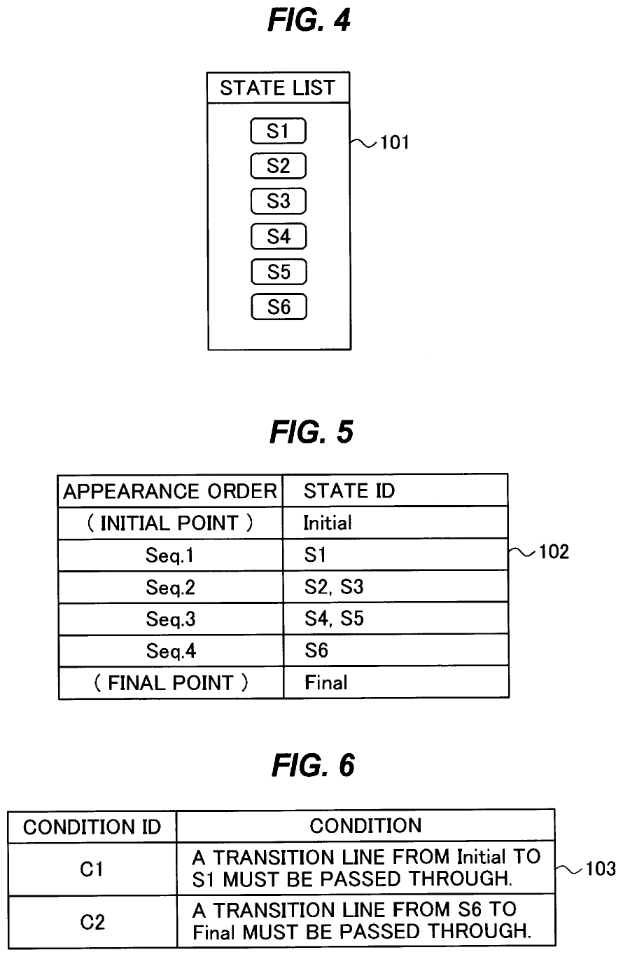

FIG. 4 is a diagram illustrating an example of a state list 101 acquired by the dialogue designer 10 of the dialogue device 1. FIG. 5 is a diagram illustrating an example of an appearance order that is a construction condition 102 acquired by the dialogue designer 10 of the dialogue device 1. FIG. 6 is a diagram illustrating an example of transition information that is a construction condition 103 acquired by the dialogue designer 10 of the dialogue device 1.

First, in step ST101, the state list input unit 11 of the dialogue designer 10 acquires the state list 101, which is a list of states (A1 in FIG. 1) necessary for implementing a dialogue function. Here, the dialogue states indicate processing states of processes executed by the device in dialogue scenarios. Examples of the dialogue states include “a state in which a telop (which is on-screen information, such as a text, a caption, a subtitle, or a scrolling ticker) is displayed”, “a state in which a guidance voice is output”, and “a state in which speech recognition information is loaded”. For example, the state list 101 is obtained from dialogue design information, such as functional specifications, previously prepared by a designer of the device. The state list 101 may be changed as needed by the designer in designing the dialogue function.

Then, in step ST102, the construction condition input unit 12 of the dialogue designer 10 acquires the construction conditions 102 and 103 (A2 in FIG. 1). States S1 to S6 included in the state list 101 illustrated in FIG. 4 are an example of states for providing the dialogue function.

The construction condition 102 illustrated in FIG. 5 indicates the appearance order of states S1 to S6 illustrated in FIG. 4 in the dialogue function. The appearance order is indicated by the arrangement of the states defined at the stage of the functional specifications. The appearance order illustrated in FIG. 5 is an appearance order of the states for representing the dialogue function that is always applied whenever any dialogue scenario is set. The appearance order is information, such as “after a beep sound is sounded, speech recognition is started”, or “after telop A is displayed, telop B is displayed”.

In the construction condition 102 of FIG. 5, no appearance order is specified between states S2 and S3 and between states S4 and S5. States S2 and S3 in the construction condition 102 have a relation in which it does not matter which of them is executed first (i.e., a relation of unconstrained order). States S4 and S5 in the construction condition 102 have a relation in which it does not matter which of them is executed first (i.e., a relation of unconstrained order). The construction condition 102 in FIG. 5 includes an initial point “Initial” and a final point “Final”, which are states that do not exist in the state list 101. These are special states indicating a start and an end of a state chart. The initial point “Initial” and final point “Final” are added as needed. Also, multiple initial points “Initial” and multiple final points “Final” may be added as needed. Also, the final point “Final” need not appear at the end of the state chart.

The construction condition 103 illustrated in FIG. 6 specifies constraints regarding transition lines connecting between states in a state chart. The construction condition 103 of FIG. 6 defines transitions that are transitions from certain states to other states and that always occur in any dialogue scenario. The content of the construction condition 103 of FIG. 6 provides structural constraints determined at the stage of preparation of the functional specifications. Condition (or condition ID) C1 defined in the construction condition 103 includes “the process of any dialogue scenario must pass through a transition line from Initial to state S1”, i.e., “any dialogue scenario must be started from state S1”. Also, condition C2 defined in the construction condition 103 includes “the process of any dialogue scenario must pass through a transition line from state S6 to Final”, i.e., “any dialogue scenario must end after passing through state S6”.

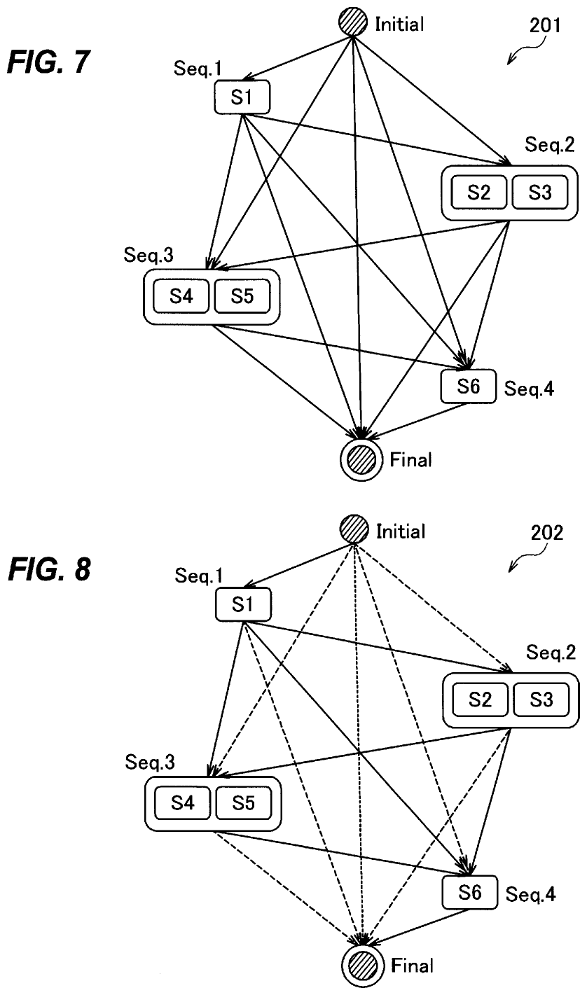

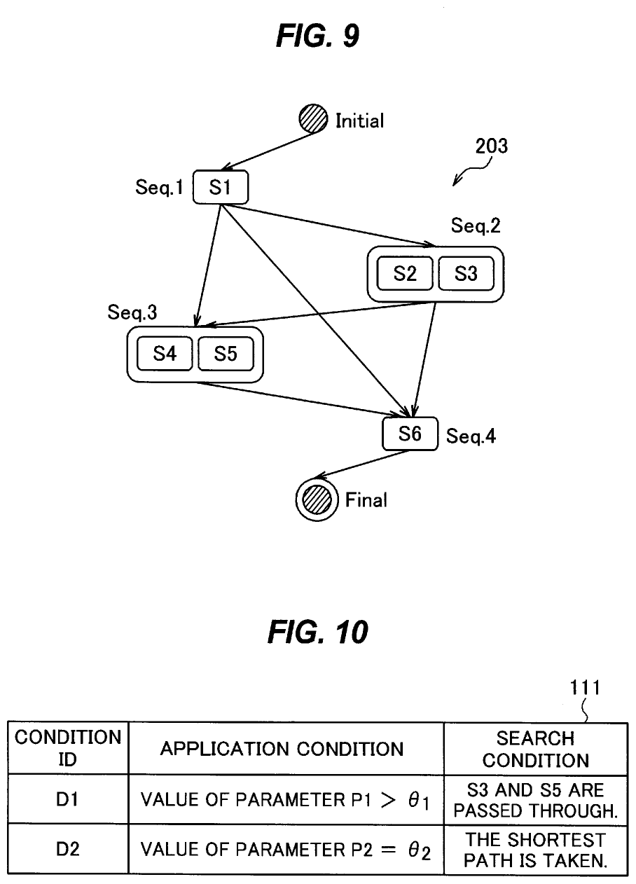

Then, in step ST103, the state chart constructor 13 creates a state chart (A3 in FIG. 1) by applying the construction conditions 102 and 103 acquired in step ST102 to the state list 101 acquired in step ST101. FIG. 7 is a diagram illustrating an example 201 of a complete directed graph constructed from the state list 101 by the state chart constructor 13 of the dialogue designer 10. FIG. 8 is a diagram illustrating an example 202 of the complete directed graph (which is the graph depicted by the solid lines and the dashed lines) constructed by the state chart constructor 13 and a state chart (which is the graph depicted by the solid lines) created from the complete directed graph. FIG. 9 is a diagram illustrating an example 203 of the state chart (which is the graph depicted by the solid lines) in FIG. 8. The content of the process by the state chart constructor 13 of the dialogue designer 10 will be described based on FIGS. 7 to 9.

First, as illustrated in FIG. 7, the state chart constructor 13 applies the construction condition 102 to the state list 101 to create a state chart in which the state moves along transition lines from Initial to Final. For example, as illustrated in FIG. 7, the state chart 201 is constructed as a complete directed graph that has the states of the state chart 201 as nodes and the transition lines connecting between the nodes as edges and in which the processing state moves from nodes having smaller sequence (Seq.) numbers toward nodes having greater sequence (Seq.) numbers. Specifically, in the state chart 201, transition lines are provided from the earliest state S1 to the other states S2 to S6. Also, transition lines are provided from the second earliest states S2 and S3 to the states S4 to S6 other than the state S1. States given the same sequence (Seq.) number are taken as states of one group and treated as if one state. In the state chart 201, they are defined as a nested state. In the state chart 201, transition lines are also provided to the remaining states in the same manner. Through the above process, the state chart 201 as a complete directed graph is obtained.

Then, the state chart constructor 13 applies the construction condition 103 to the obtained state chart 201. By applying condition C1 of the construction condition 103 that “the process of any dialogue scenario must pass through a transition line from Initial to S1”, all the transition lines from Initial other than the transition line to state S1 (i.e., the solid transition line in FIG. 8) (i.e., the dashed transition lines in FIG. 8) are discarded (i.e., not employed).

Similarly, by applying condition C2 that “the process of any dialogue scenario must pass through a transition line from S6 to Final”, all the transition lines reaching Final without passing through the transition line between state S6 and Final are discarded (i.e., not employed).

FIG. 8 is a diagram illustrating an example of the complete directed graph 202 (which is the graph depicted by the solid lines and the dashed lines in FIG. 8) constructed by the dialogue designer 10 of the dialogue device 1 and the state chart (which is the graph depicted by the solid lines in FIG. 8) created from the complete directed graph 202. FIG. 9 is a diagram illustrating the state chart 203 (which is the graph depicted by the solid lines in FIG. 8). Thus, FIG. 9 illustrates the result obtained by removing the dashed transition lines from the complete directed graph 202 of FIG. 8.

Through the process from step ST101 to ST103 of FIG. 3 described above, the state chart 203 is automatically constructed by the dialogue designer 10. In steps ST104 to ST107 of FIG. 3, the dialogue executor 20 obtains a dialogue scenario to be actually executed, from the state chart 203 created by the process until step ST103, and executes a dialogue in accordance with the dialogue scenario.

First, in step ST104, the dialogue executor 20 acquires external information that is dynamically acquired from outside when a dialogue process is started. The external information is information, such as “the road is being jammed”, “it will rain”, or “the fellow passenger in the passenger seat is asleep”, that is dynamically provided while the device to which the dialogue device 1 is applied is operated. Thus, the external information may include information on the environment or situation around the device to which the dialogue device 1 is applied.

Then, in step ST105, the dialogue executor 20 acquires one or more search conditions B2 for searching for a path on the state chart A3 (e.g., the state chart illustrated in FIG. 9). The search conditions B2 are determined in preparation of the functional specifications.

FIG. 10 is a diagram illustrating an example of the search conditions 111 (i.e., B2 in FIG. 1) acquired by the dialogue executor 20 of the dialogue device 1. In FIG. 10, each search condition 111 includes an application condition for determination of application of the condition, and a condition of passage of the path when the application condition is satisfied. The application condition is a condition, such as “the remaining amount of gasoline is less than 10 liters”, “it is raining”, or “the fellow passenger in the passenger seat is asleep”, for determination as to whether the condition acquired in step ST104 meets the condition.

The condition of passage of the path is a condition used in search for the path in the state chart A3 when the application condition is satisfied. This condition is a condition, such as “state ‘xx’ is passed through”, or “the shortest path is taken”, that indicates a way of search based on the graph structure. Also, a parameter, such modal information or score, is previously assigned to each state or each transition line, and the condition used in search for the path is a condition indicating a way of search based on parameter optimization, such as “states are passed through so that the cognitive load of the driver is minimized (e.g., the amount of visual information is minimized, or no sound is output)” or “states are passed through so that a score is maximized”. For condition (or condition ID) D1 in FIG. 10, when the application condition that “the value of parameter P1 is greater than threshold el” is satisfied, a dialogue scenario passing through states S3 and S5 is searched for. For condition D2 in FIG. 10, when the application condition that “the value of parameter P2 is equal to threshold θ1” is satisfied, a dialogue scenario is searched for so that the shortest path is taken (i.e., the number of states passed through is minimized).

Then, in step ST106, the dialogue executor 20 searches for a path by applying the search conditions acquired in steps ST104 and ST105 to the state chart created by the process until step ST103.

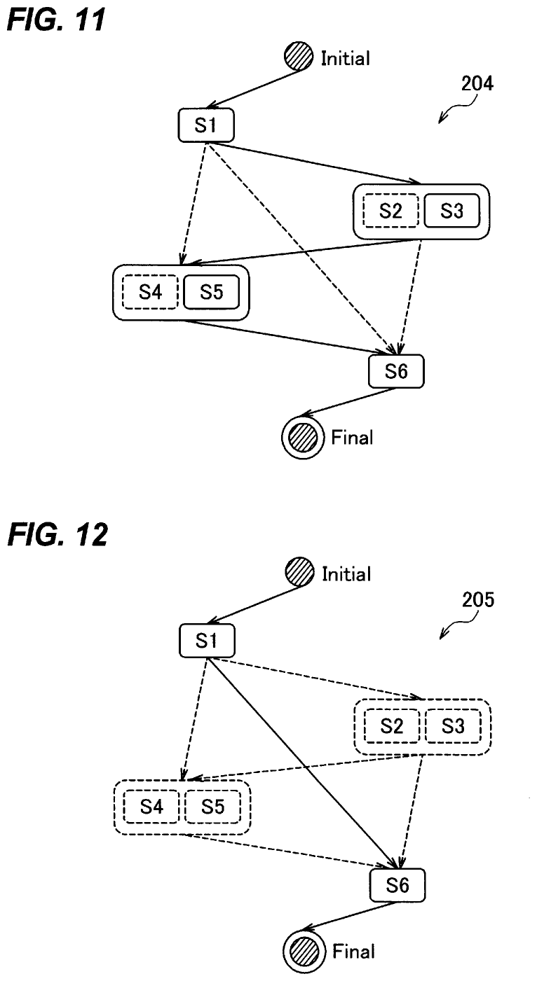

FIG. 11 is a diagram illustrating an example of the dialogue scenario 204 obtained by the dialogue executor 20 of the dialogue device 1. FIG. 12 is a diagram illustrating another example of the dialogue scenario obtained by the dialogue executor 20 of the dialogue device 1. FIGS. 11 and 12 are examples obtained by applying conditions D1 and D2 (illustrated in FIG. 10) of the search conditions 111 to the state chart 203 (illustrated in FIG. 9), respectively. In FIGS. 11 and 12, the dashed lines represent transition lines and states discarded in the search. When search condition D1 is applied to the state chart 203, dialogue scenario 204 is obtained as illustrated by the solid lines in FIG. 11. On the other hand, when search condition D2 is applied to the state chart 203, dialogue scenario 205 is obtained as illustrated by the solid lines in FIG. 12.

In final step ST107, the dialogue executor 20 reads the dialogue scenario obtained by the process until step ST106, and executes a dialogue in accordance with the dialogue scenario. The dialogue process by the dialogue executor 20 may be executed by a runtime, i.e., a runtime module, of the state chart, or may be executed by a program obtained by converting the dialogue scenario.

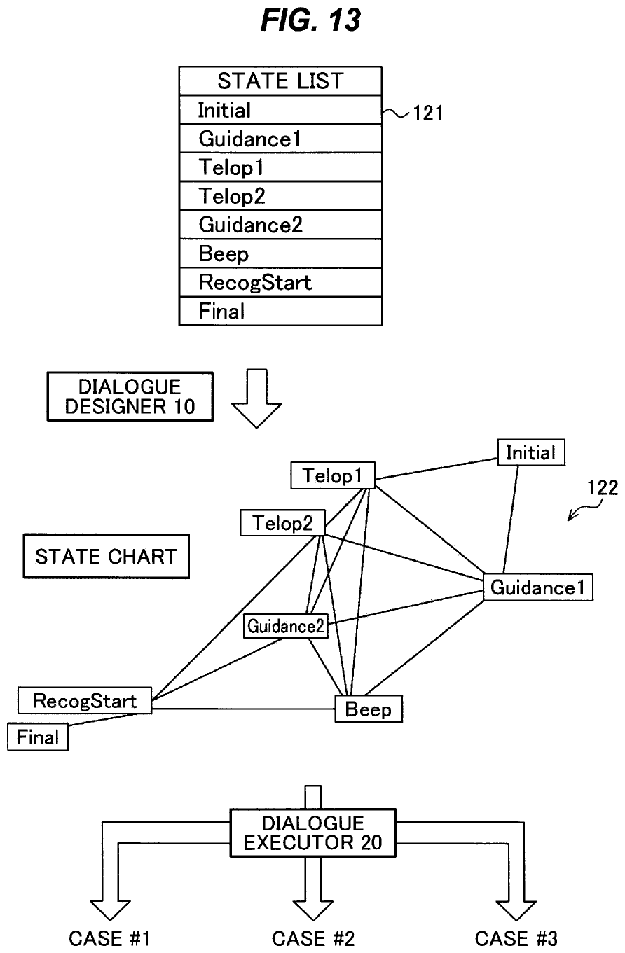

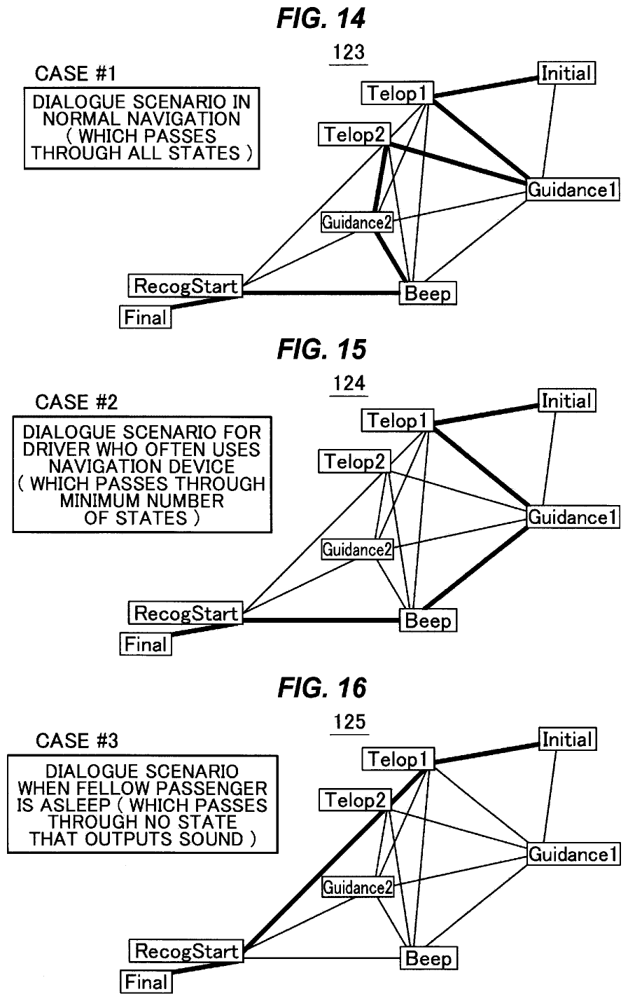

FIG. 13 is a diagram illustrating an example of a state list 121 acquired by the dialogue designer 10 of the dialogue device 1 and a state chart 122 constructed from the state list. FIG. 14 is a diagram illustrating an example of a dialogue scenario 123 in case #1 of FIG. 13. FIG. 15 is a diagram illustrating an example of a dialogue scenario 124 in case #2 of FIG. 13. FIG. 16 is a diagram illustrating an example of a dialogue scenario 125 in case #3 of FIG. 13.

The state list 121 includes multiple states (i.e., processing states) that appear in a dialogue function until start of speech recognition of the dialogue device 1. The state list 121 includes, for example, guidance voice outputs “Guidance1” and “Guidance2”, telop displays “Telop1” and “Telop2”, a beep sound output “Beep”, a speech recognition start “RecogStart”, an initial point “Initial”, and a final point “Final”.

The dialogue designer 10 obtains the state chart 122 by applying various construction conditions to the state list 121. By searching for a path in the state chart 122 by applying a search condition corresponding to the surrounding situation, which dynamically changes, a dialogue scenario appropriate for the surrounding situation is dynamically obtained, for example. Of the paths of the dialogue scenarios 123 to 125 illustrated in FIGS. 14 to 16, the heavy line paths are dialogue scenarios obtained as results of searches in the state chart 122.

For example, the path of the dialogue scenario 123 illustrated in FIG. 14 is a path that passes through all the states in the state chart 122. The path of the dialogue scenario 123 illustrated in FIG. 14 indicates a path of a dialogue scenario in normal situations in which no special situation occurs (i.e., a normal dialogue scenario).

In the path of the dialogue scenario 124 illustrated in FIG. 15, the number of telop outputs is one less than the number of telop outputs in the normal dialogue scenario 123 illustrated in FIG. 14, and the number of guidance voice outputs is one less than the number of guidance voice outputs in the normal dialogue scenario 123 illustrated in FIG. 14. Thus, the path of the dialogue scenario 124 illustrated in FIG. 15 is a shortcut path, compared to the path of the normal dialogue scenario 123 illustrated in FIG. 14. The path of the dialogue scenario 124 illustrated in FIG. 15 is, for example, a path that is employed when the user is a driver who is used to using the car navigation device. The path of the dialogue scenario 124 illustrated in FIG. 15 can be used as a dialogue scenario with only minimal dialogue.

The path of the dialogue scenario 125 illustrated in FIG. 16 passes through none of the processes of outputting guidance voice or beep sound. The path of the dialogue scenario 125 illustrated in FIG. 16 can be used as a dialogue scenario that avoids the processes that output sound, for example, in situations where a fellow passenger is asleep.

### <<1-3>> Advantages of First Embodiment

As described above, by using the dialogue device 1, dialogue method, or dialogue program according to the first embodiment, it is possible to dynamically determine dialogue scenarios satisfying various conditions and execute advanced dialogues on the basis of the dialogue scenarios. Also, no manual operation is required to create dialogue scenarios.

### <<1-4>> Modifications of First Embodiment

In the first embodiment, the construction condition input unit 12 may acquire, as an input, a condition, such as a transition relation, an order relation, or a constraint condition of transition lines, that describes the structure itself of a state chart. Also, in the first embodiment, the construction condition input unit 12 may acquire, as an input, a construction condition, such as degrees of importance of states or transition lines, that does not directly indicate the structure of a state chart.

Also, in the first embodiment, the construction condition input unit 12 may acquire, as an input, a construction condition, such as a design pattern indicating the structure of a state chart or a template for a state chart, that predefines the structure of a state chart to some extent. Also, in the first embodiment, the construction condition input unit 12 may acquire, as an input, a combination of a template and a specific construction condition. An example using a template for dialogue will be described in a second embodiment.

Also, the dialogue input unit 21 may receive, as an input, various information from the application 34 or the like. For example, in a car navigation device, it may receive, as an input, in-vehicle information from the application 34. The in-vehicle information in this case may include the vehicle speed, the state of the brake, the steering angle of the steering wheel, profile information of the driver, sensing data obtained by detecting the state of the driver, or the like.

Also, when the dialogue device 1 is applied to a car navigation device, the dialogue input unit 21 may receive, as an input, information on the situation around the vehicle, or the like. The information on the situation around the vehicle may include, for example, map information including the running position, traffic jam information around the running position, the ambient temperature outside the vehicle, or the like.

Also, when the dialogue device 1 is applied to an air conditioner that is an electrical household appliance, the dialogue input unit 21 may receive, as an input, information on the operation environment, such as the indoor temperature, the number of persons in the room, or the outdoor temperature. Also, when the dialogue device 1 is applied to an air conditioner that is an electrical household appliance, the dialogue input unit 21 may receive, as an input, information regarding the behavior or state of a user, such as a person in the room is asleep, or a person in the room is eating. Also, when the dialogue device 1 is applied to an air conditioner that is an electrical household appliance, the dialogue input unit 21 may employ a method of adaptively obtaining an optimum path (i.e., dialogue scenario) from the state chart on the basis of user operation history information. A device using a user operation history will be described in a third embodiment.

Also, the dialogue scenario searcher 23 may select only one search condition and use it for the search, or may select multiple search conditions or a search condition obtained by combining them and use them or it for the search. When the dialogue scenario searcher 23 performs the search by using a search condition obtained by combining multiple search conditions, conflicts may occur between search conditions. By previously setting priorities for the search conditions, the dialogue scenario searcher 23 can appropriately perform the search. For example, the dialogue scenario searcher 23 can appropriately perform the search by sequentially applying the search conditions in descending order of the priorities, and when a conflict occurs, stopping or skipping the application of the search condition at this time.

Also, the dialogue scenario searcher 23 can use, for the search, a common algorithm used in graph theory. In such search, search algorithms of combination sets described in Non-Patent Literature 1 may be used, for example.
Non-Patent Literature 1: MINATO, Shin-ichi. “Zero-suppressed BDDs for set manipulation in combinatorial problems. In: Proceedings of the 30th international Design Automation Conference”, ACM, 1993. pp. 272-277.

### <<2>> Second Embodiment

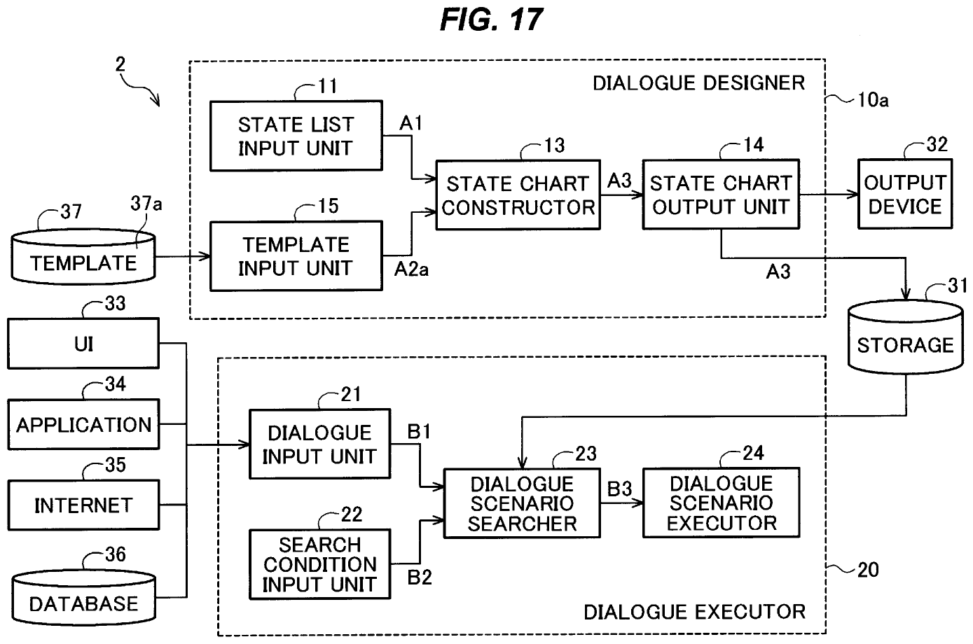

FIG. 17 is a block diagram schematically illustrating a configuration of a dialogue device 2 according to the second embodiment of the present invention. The dialogue device 2 is a device capable of implementing a dialogue method according to the second embodiment. In FIG. 17, elements that are the same as or correspond to those illustrated in FIG. 1 are given the same reference characters as in FIG. 1. The dialogue device 2 according to the second embodiment differs from the dialogue device 1 according to the first embodiment in that it includes a template input unit 15 of a dialogue designer 10a instead of the construction condition input unit 12 of the dialogue designer 10 of the first embodiment. The template input unit 15 acquires one or more templates 37a from a database of a template storage 37. However, the dialogue device 2 according to the second embodiment may include the template input unit 15 of the dialogue designer 10a, in addition to the construction condition input unit 12 of the dialogue designer 10 of the first embodiment.

In the second embodiment, the template input unit 15 of the dialogue designer 10a acquires a template 37a for dialogue to previously prepare it, for each dialogue scenario. For example, dialogues that are somewhat common processes regardless of the device to which the dialogue device is applied, such as a dialogue in which a YES or NO answer is given, or an option dialogue in which a selection of one or more of multiple options is given as an answer, are prepared as a template state chart or a part of a state chart. The state chart constructor 13 at the subsequent stage constructs a state chart A3 by applying a state list acquired by a state list input unit 11 to one or more templates A2a. Except for the above, the dialogue device 2 according to the second embodiment is the same as the dialogue device 1 according to the first embodiment.

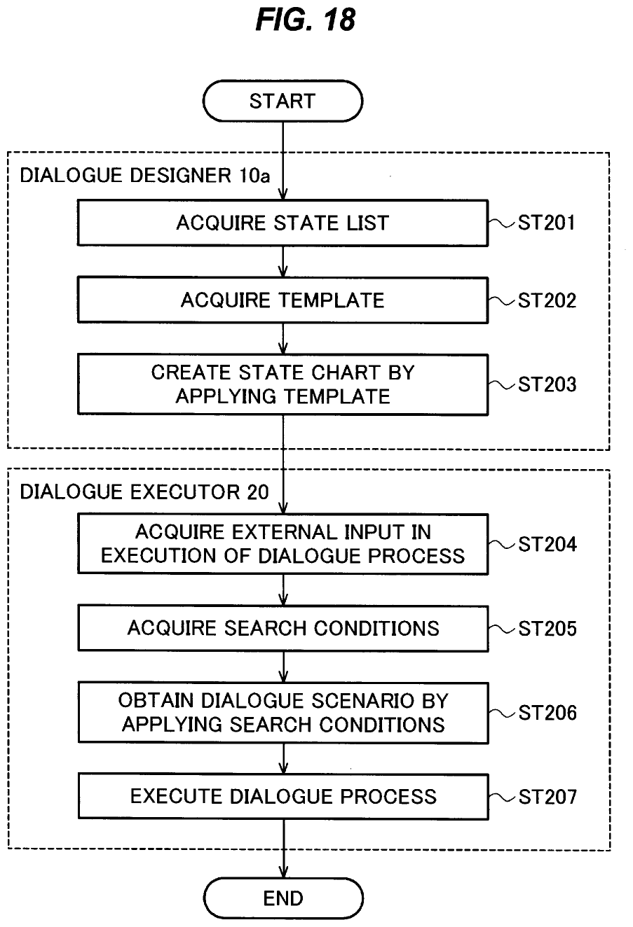

FIG. 18 is a flowchart illustrating an operation of the dialogue device 2 according to the second embodiment. As illustrated in FIG. 18, the operations in steps ST201 and ST204 to ST207 of the dialogue device 2 according to the second embodiment are the same as those in steps ST101 and ST104 to ST107 of the dialogue device 1 according to the first embodiment. The operations in steps ST202 and ST203 of the dialogue device 2 according to the second embodiment differ from those in steps ST102 and ST103 of the dialogue device 1 according to the first embodiment.

In the second embodiment, after the state list input unit 11 acquires a state list in step ST201, the template input unit 15 acquires one or more templates 37a for dialogue in step ST202. Here, the dialogue templates 37a are previously prepared and stored as a database in the template storage 37. The dialogue templates 37a may be manually constructed, or may be selected from design patterns. Alternatively, the dialogue templates 37a may be existing data, such as design data in a previous dialogue function development. Further, as the dialogue templates 37a, data obtained by appropriately editing existing data may be stored as a database in the template storage 37 and used.

In step ST203, the state chart constructor 13 creates a state chart A3 by applying the states acquired in step ST201 to the templates A2a acquired in step ST202. Information such as the positions where the states are applied or the order in which the states are applied may be collated with information, such as an appearance order, previously assigned to each state as a construction condition and automatically performed, or a method of appropriately manually applying them may be employed. The processes from step ST204 are the same as those from step ST104 in the first embodiment.

As described above, by using the dialogue device 2, dialogue method, or dialogue program according to the second embodiment, it is possible to dynamically determine dialogue scenarios satisfying various conditions and execute advanced dialogues on the basis of the dialogue scenarios.

Also, by using the dialogue templates, since a large part of the construction of the state chart, which has been conventionally constructed entirely manually, is automatically performed, the design man-hours are reduced. Also, a user who is not a professional engineer can easily design a dialogue.

### <<3>> Third Embodiment

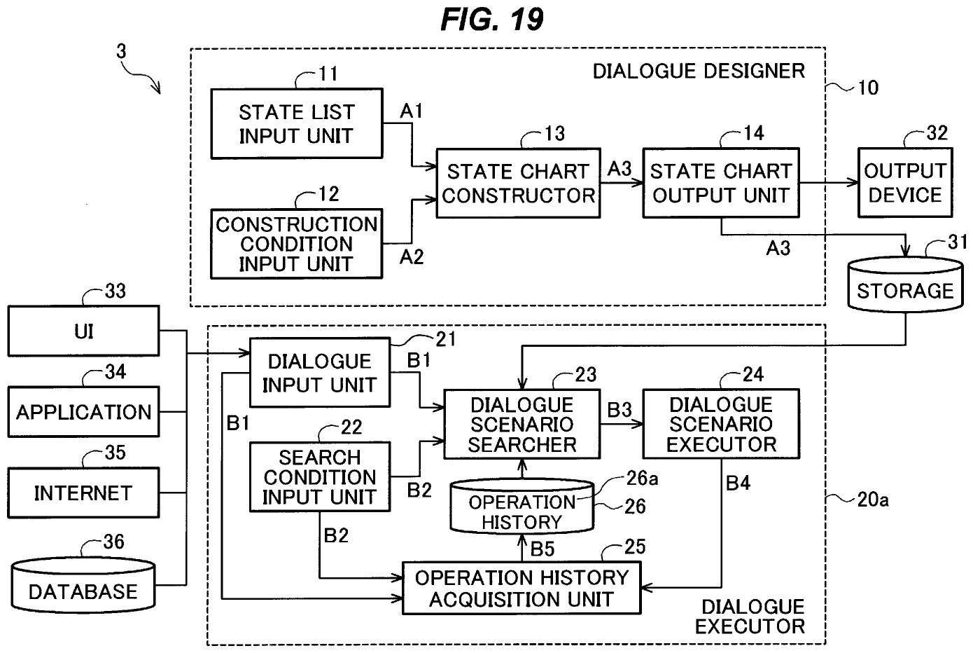

FIG. 19 is a block diagram schematically illustrating a configuration of a dialogue device 3 according to the third embodiment of the present invention. The dialogue device 3 is a device capable of implementing a dialogue method according to the third embodiment. In FIG. 19, elements that are the same as or correspond to those illustrated in FIG. 1 are given the same reference characters as in FIG. 1. The dialogue device 3 according to the third embodiment differs from the dialogue device 1 according to the first embodiment in that it includes a dialogue executor 20a including an operation history acquisition unit 25 and an operation history storage 26 that stores an operation history 26a, instead of the dialogue executor 20 of the first embodiment.

In the third embodiment, the dialogue executor 20a includes a dialogue input unit 21, a search condition input unit 22, and the operation history acquisition unit 25, which acquires an operation history of a user from a dialogue scenario executor 24. The operation history acquisition unit 25 stores, as operation history information B5, in the operation history storage 26, content input by the user through the dialogue input unit 21 in response to a dialogue scenario B4 executed by the dialogue scenario executor 24, and the search condition at this time, together with the dialogue scenario. In the dialogue scenario search, when a similar search condition appears, a path weighted by the operation history of the user to reproduce a previous dialogue response of the user is searched for. Otherwise, the dialogue device 3 according to the third embodiment is the same in configuration as the dialogue device 1 according to the first embodiment.

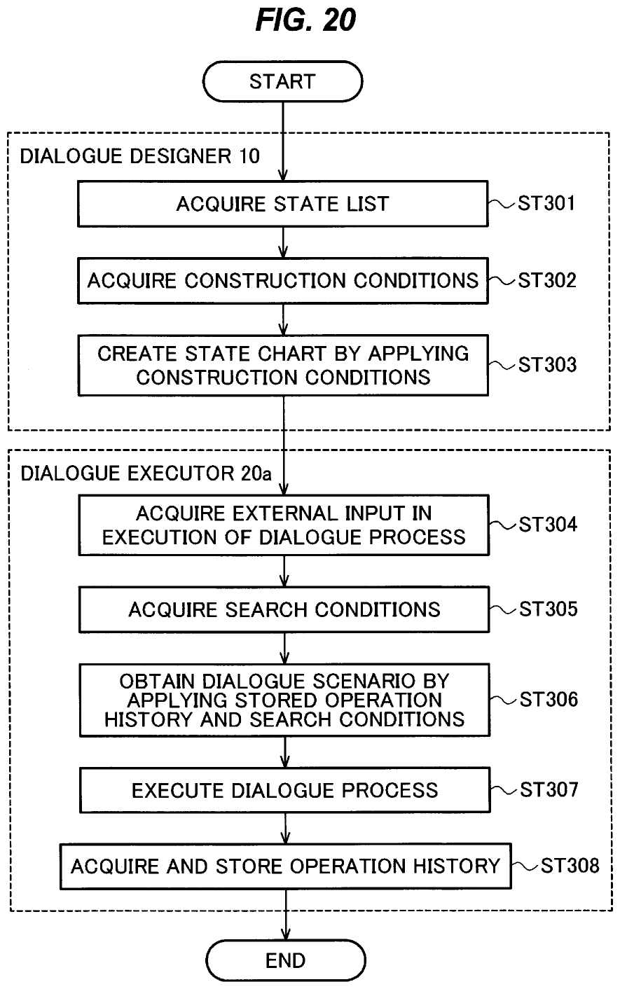

FIG. 20 is a flowchart illustrating an operation of the dialogue device 3 according to the third embodiment. As illustrated in FIG. 20, the operations of steps ST301 to ST305 of the dialogue device 3 according to the third embodiment are the same as those of steps ST101 to ST105 of the dialogue device 1 according to the first embodiment. The operations of steps ST306 to ST308 of the dialogue device 3 according to the third embodiment differ from those of steps ST106 and ST107 of the dialogue device 1 according to the first embodiment.

In the third embodiment, in step ST308, the dialogue executor 20a stores, as the operation history 26a, in the operation history storage 26, the operation performed by the user during the execution of the dialogue process, the search condition of the dialogue scenario, and the dialogue scenario at this time, in association with each other. For example, the dialogue executor 20a prepares a table with the dialogue scenario as a key, and stores, as a record thereof, the operation content (e.g., a selected state), the search condition (e.g., the value of a parameter), or the like.

In step ST306, the dialogue scenario searcher 23 of the dialogue executor 20a searches for a dialogue scenario by using the operation history 26a stored in step ST308 in one or more previous dialogues. The steps of the third embodiment other than the above steps are the same as those of the first embodiment.

As described above, by using the dialogue device 3, dialogue method, or dialogue program according to the third embodiment, it is possible to dynamically determine dialogue scenarios satisfying various conditions and execute advanced dialogues on the basis of the dialogue scenarios.

Also, in the third embodiment, it is possible to provide a dialogue scenario appropriate for an operation that is expected to be performed by a user. Specifically, by using the dialogue device 3, dialogue method, or dialogue program according to the third embodiment, it is possible to provide a dialogue function that allows a user to perform an operation more comfortably. For example, when no operation history is used, an operation instruction that “when the temperature is 25° C., the set temperature of the air conditioner should be lowered” and an operation instruction that “when the temperature is 25° C., a window should be opened” as search conditions are provided as dialogues. However, in the third embodiment, in a case where an operation history indicating that a window is opened when the temperature is 25° C. is stored, when the temperature becomes 25° C., the dialogue executor 20a can create the dialogue scenario so that a dialogue scenario that recommends opening a window is given priority.

### <<4>> Modifications

The configurations described in the first to third embodiments may be appropriately combined with each other. Also, the hardware configuration illustrated in FIG. 2 is applicable to the second and third embodiments.

### DESCRIPTION OF REFERENCE CHARACTERS

1, 2, 3 dialogue device, 10, 10a dialogue designer, 11 state list input unit, 12 construction condition input unit, 13 state chart constructor, 14 state chart output unit, 15 template input unit, 20, 20a dialogue executor, 21 dialogue input unit, 22 search condition input unit, 23 dialogue scenario searcher, 24 dialogue scenario executor, 25 operation history acquisition unit, 26 operation history storage, 26a operation history information, 31 storage, 32 output device, 33 user interface (UI), 34 application, 35 Internet (network), 36 database, 37 template storage, 37a templates, A1 states, A2 construction conditions, A2a templates, A3 state chart, B1 external information, B2 search conditions, B3 dialogue scenario, B4 executed dialogue scenario, B5 operation history information.

What is claimed is:

1. A dialogue device to execute a dialogue with a user in accordance with a dialogue scenario, the dialogue device comprising:
a processor to execute a program; and
a memory to store the program which, when executed by the processor, performs processes of:
(a) acquiring a plurality of processing states in dialogue and relation information indicating a relation between the plurality of processing states, and constructing, on a basis of the plurality of processing states and the relation information, a diagram describing an entirety of a designed dialogue function; and
(b) searching, on a basis of information dynamically acquired before an actual dialogue from a surrounding situation in using the dialogue device, the diagram describing the entirety of the designed dialogue function for one or more processing states that appear in the actual dialogue, among the plurality of processing states in the diagram describing the entirety of the designed dialogue function, and dynamically determining the dialogue scenario including the processing states obtained by the search.

2. The dialogue device of claim 1, wherein the diagram describing the entirety of the designed dialogue function includes one of a state chart, a behavior tree, an activity diagram, a sequence diagram, an XML diagram, and a graph.

3. The dialogue device of claim 1, wherein
the relation information includes transition information indicating one or more transitions between the plurality of processing states and order information indicating an appearance order of each of the plurality of processing states, and
process (a) constructs the diagram describing the entirety of the designed dialogue function, on a basis of the transition information and the order information.

4. The dialogue device of claim 1, wherein
the relation information includes a template describing a predetermined dialogue function, and
process (a) constructs the diagram describing the entirety of the designed dialogue function, on a basis of the template.

5. The dialogue device of claim 4, further comprising a template storage to previously store the template.

6. The dialogue device of claim 1, wherein the information dynamically acquired before the actual dialogue includes one or more of user operation information provided through a user interface, information provided from an application, information provided through a network, and information provided from a database.

7. The dialogue device of claim 1, wherein the information dynamically acquired before the actual dialogue includes a search condition that is a condition that needs to be satisfied by the processing states included in the dialogue scenario.

8. The dialogue device of claim 1, wherein process (b) includes:
executing the actual dialogue in accordance with the dialogue scenario;
storing, in an operation history storage, operation history information in which the information acquired before the execution of the actual dialogue and an operation history in the dialogue scenario used in the actual dialogue are associated with each other; and
searching the diagram describing the entirety of the dialogue function for the processing states that appear in the actual dialogue, on a basis of the operation history information stored in the operation history storage, and dynamically determining the dialogue scenario including the processing states obtained by the search.

9. The dialogue device of claim 1, further comprising a storage to store the diagram describing the entirety of the designed dialogue function constructed in process (a),
wherein process (b) dynamically determines the dialogue scenario from the diagram describing the entirety of the designed dialogue function stored in the storage.

10. A dialogue method executed by a dialogue device that executes a dialogue with a user in accordance with a dialogue scenario, the dialogue method comprising:
acquiring a plurality of processing states in dialogue and relation information indicating a relation between the plurality of processing states, and constructing, on a basis of the plurality of processing states and the relation information, a diagram describing an entirety of a designed dialogue function; and
searching, on a basis of information dynamically acquired before an actual dialogue from a surrounding situation in using the dialogue function, the diagram describing the entirety of the designed dialogue function for one or more processing states that appear in the actual dialogue, among the plurality of processing states in the diagram describing the entirety of the designed dialogue function, and dynamically determining the dialogue scenario including the processing states obtained by the search.

11. A non-transitory computer-readable storage medium storing a dialogue program for causing a computer to execute a dialogue in accordance with a dialogue scenario, the dialogue program causing the computer to execute:
a process of acquiring a plurality of processing states in dialogue and relation information indicating a relation between the plurality of processing states, and constructing, on a basis of the plurality of processing states and the relation information, a diagram describing an entirety of a designed dialogue function; and
a process of searching, on a basis of information dynamically acquired before an actual dialogue from a surrounding situation in using the dialogue function, the diagram describing the entirety of the designed dialogue function for one or more processing states that appear in the actual dialogue, among the plurality of processing states in the diagram describing the entirety of the designed dialogue function, and dynamically determining the dialogue scenario including the processing states obtained by the search.
